(19) United States
(12) Patent Application Publication
(10) Pub. No.: US 2009/0273187 A1
(43) Pub. Date: Nov. 5, 2009

(54) Control Method

(76) Inventors: Lars Gertmar, Vasteras (SE); Leif-Erik Wraae, (US); Helle Wraae, Brylle (DK); Hans C. Christensen, Copenhagen (DK); Juhani Mantere, Tuusula (FI); Erik Koldby, Odense (DK)

Correspondence Address: ST. ONGE STEWARD JOHNSTON & REENS, LLC, 986 BEDFORD STREET, STAMFORD, CT, 06905-5619, US

(21) Appl. No.: 12/413,025

(22) Filed: Mar. 27, 2009

Related U.S. Application Data
(63) Continuation of application No. PCT/SE2006/001107, filed on Sep. 29, 2006.

(51) Int. Cl. H02P 9/04

(52) U.S. Cl. 290/44

(57) ABSTRACT

A generator of a wind turbine is at low power conditions operated as a motor by control of a frequency converter to feed electric power from an electric power transmission network to the generator for raising the speed of the wind rotor above a predetermined level for lubricating rotating parts of a drive train of the wind turbine.

### CROSS-REFERENCE TO RELATED APPLICATIONS

The present application is a continuation of pending International patent application PCT/SE2006/001107 filed on Sep. 29, 2006 which designates the United States, the content of which is incorporated herein by reference.

### FIELD OF THE INVENTION

The present relates to a wind turbine comprising a drive train with a wind rotor connected to a generator rotor through a gear box and having bearings for journalling rotating parts of the drive train, said generator being adapted to be connected to an electric power transmission network.

### BACKGROUND OF THE INVENTION

Accordingly, “wind turbine” is in this disclosure defined to include a wind rotor with turbine blades, gearbox, generator and associated equipment as well as equipment used for feeding electric power from the generator to said electric power transmission network or a transformer connected thereto.

The generator in said wind turbine may be of any known type, such as an asynchronous generator with stator windings adapted to be connected to said electric power transmission network and a rotor being connected through slip-rings and brushes to a frequency converter, an asynchronous generator having a squirrel cage wound rotor or a synchronous generator.

Low power conditions, which means low wind velocities and/or low wind rotor speed, occur for a wind turbine seasonally as well as daily, and such conditions means increased stress on parts of said drive train in known wind turbines. When such conditions prevail the wind turbines are kept at standstill, idling or low-speed operation, and this stresses the drive train components like gearboxes, bearings and brushes/slip-rings when present. One reason for this is that lubrication of different components is reduced during these conditions, since no safe film of lubricating oil/grease will be formed in the bearings. Furthermore, indentations may under such conditions damage the surfaces normally lubricated during normal power conditions and periodically overrun by bearing balls. Especially for offshore wind parks, this can be devastating, since the time and costs required to repair a gearbox and/or bearing will then be particularly high.

Efforts are made to develop cost-effective, more reliable drive trains for increasing the energy yield of wind turbines, which is highly dependent upon the availability times.

### SUMMARY OF THE INVENTION

It is an object of the present invention to provide a wind turbine for which said problems arising when low power conditions prevail have been substantially reduced, so that the need of repair of parts of the drive train will arise less frequently and by that the energy yield of the wind turbine will be increased.

This object is according to the invention obtained by providing a wind turbine, which further comprises a frequency converter connecting with one side to the generator and adapted to connect with the other side to said network, a control unit for controlling this converter and means adapted to sense the wind velocity in the region of the wind turbine and/or means adapted to sense the speed of the wind rotor, which wind turbine is characterized in that it further comprises means adapted to determine, on the basis of information from said sensing means, whether low power conditions, defined by a wind velocity and/or a wind rotor speed below a respective predetermined value, prevail, and that said control unit is adapted to control said frequency converter, upon determining that said low power conditions prevail, to feed electric power to said generator for motor operation thereof for raising the speed of the wind rotor above a predetermined level for lubricating parts of said drive train during said low power conditions.

By operating the generator of the wind turbine as a motor during said low power condition the turbine will no longer be kept at standstill or idling, tugging and disjointing, but it is ensured that the speed of the wind rotor is kept above a predetermined level for efficiently lubricating parts of bearings and the gearbox. This avoids damage of surfaces normally lubricated and periodical overrun by bearing balls. Thus, the period of times between a need of repair of components of the drive train arises may be substantially prolonged, which involves a considerable saving of costs, especially in labour and as a consequence of reduced losses during time periods of repair of the wind turbine. The costs of the electric energy needed for obtaining a sufficient speed of the wind rotor for obtaining suitable lubrication during such low power conditions are low in comparison with the savings made due to said lubrication obtained.

According to an embodiment of the invention said wind turbine has a generator in the form of a so-called Double-Fed Induction Generator (DFIG) with two parallel branches connecting the generator to said electric power transmission network for feeding electric power to the network through both said branches, in which said frequency converter is arranged in one of the branches and adapted to under normal power conditions be controlled by said control unit to convert electric power delivered from the generator with a frequency of the generator to electric power having the frequency of said electric power network. A majority of the wind turbines manufactured, erected and commissioned in recent years have such Double-Fed Induction Generators making it possible to modify such known wind turbines by simple means for obtaining a wind turbine according to the invention with favourable operation at low power conditions.

According to another embodiment of the invention said generator is an asynchronous generator having stator windings adapted to be connected to said electric power transmission network and a rotor being connected to slip-rings and brushes to said frequency converter, the wind turbine further comprises means adapted to short-circuit the stator windings of the generator upon determination that said low power conditions prevail, and said control unit is adapted to control said frequency converter, upon determining that said low power conditions prevail, to feed electric power to the rotor of the generator through the connection of the brushes and slip-rings thereto for raising the speed of the wind rotor above a predetermined level for lubricating rotating parts of said drive train. This does not only mean a proper lubrication of components in the gearbox and bearings of the wind turbine at low power conditions, but the slip-rings of such a generator will also be lubricated by the arcs created through said electric power fed through the connection of the brushes and slip-rings reducing the wear of the slip-rings and the brushes.

According to another embodiment of the invention said control unit is adapted to control said frequency converter at said low power conditions to deliver a current through the brushes/slip-rings connection having an appearance favourable for lubrication of this connection. By appropriately controlling the frequency converter to deliver a current of a desired appearance the lubrication of the slip-rings may be further improved.

According to another embodiment of the invention the wind turbine comprises means adapted to operate the generator with a lower air-gap flux upon determination of said low power conditions for increasing the level of the current through the brushes/slip-rings connection for lubricating the slip-rings. Such an increased current level will improve the lubrication of the slip-rings and by that result in reduced wear thereof.

According to another embodiment of the invention said generator is an asynchronous generator with a squirrel cage wound rotor and stator windings adapted to be connected to said electric power network through said frequency converter, and said control unit is adapted to control said frequency converter, upon determination that said low power conditions prevail, to feed electric power to the stator windings of the generator for operating this as a motor.

According to a still further embodiment of the invention said determination means is adapted to determine that low power conditions prevail when said wind velocity and/or wind rotor speed sensed is below a value making it possible to generate a maximum power being below 5% or 2% of the rated power of the wind turbine. These are suitable definitions of low power conditions ensuring on one hand that the generator is operated as a motor under all conditions otherwise involving a risk of damage of components of the drive train due to poor lubrication and on the other that the generator is not operated as a motor when there is a possibility to operate it as a generator without any risk whatsoever of poor lubrication.

The invention also relates to a method for controlling a wind turbine at low power conditions according to the appended independent method claim. The advantages and advantageous features of such a method and the embodiments thereof defined in the appended dependent claims appear from the discussion above of the wind turbine according to the invention and embodiments thereof.

The invention also relates to a computer program as well as a computer readable medium according to the corresponding appended claims. The steps of the method according to the invention are well suited to be controlled by a processor provided with such a computer program.

The invention also comprises a use of a wind turbine according to the invention together with a plurality of such wind turbines in a wind power plant, such as including an at least partially offshore wind park as well as a use in an electric power transmission system comprising a High Voltage Direct Current (HVDC) transmission line. These uses are particularly advantageous uses of a wind turbine according to the invention, since repair of parts is in these uses of a wind turbine associated with considerable costs, not at least as a consequence of loss of energy yield due to time to repair.

Other advantages as well as advantageous features of the invention will appear from the following description.

### BRIEF DESCRIPTION OF THE DRAWINGS

With reference to the appended drawing, below follows a specific description of embodiments of the invention cited as examples.

In the drawing:

FIG. 1 is a very schematic view of a wind turbine having a so-called Double-Fed Induction Generator (DFIG), the construction of which being known as such,

FIG. 2 is a simplified view illustrating a wind turbine according to a first embodiment of the invention and being of the type shown in FIG. 1, and

FIG. 3 is a view similar to that of FIG. 2 of a wind turbine according to a second embodiment of the invention being of a slightly different type than that according to FIG. 1.

### DETAILED DESCRIPTION OF THE INVENTION

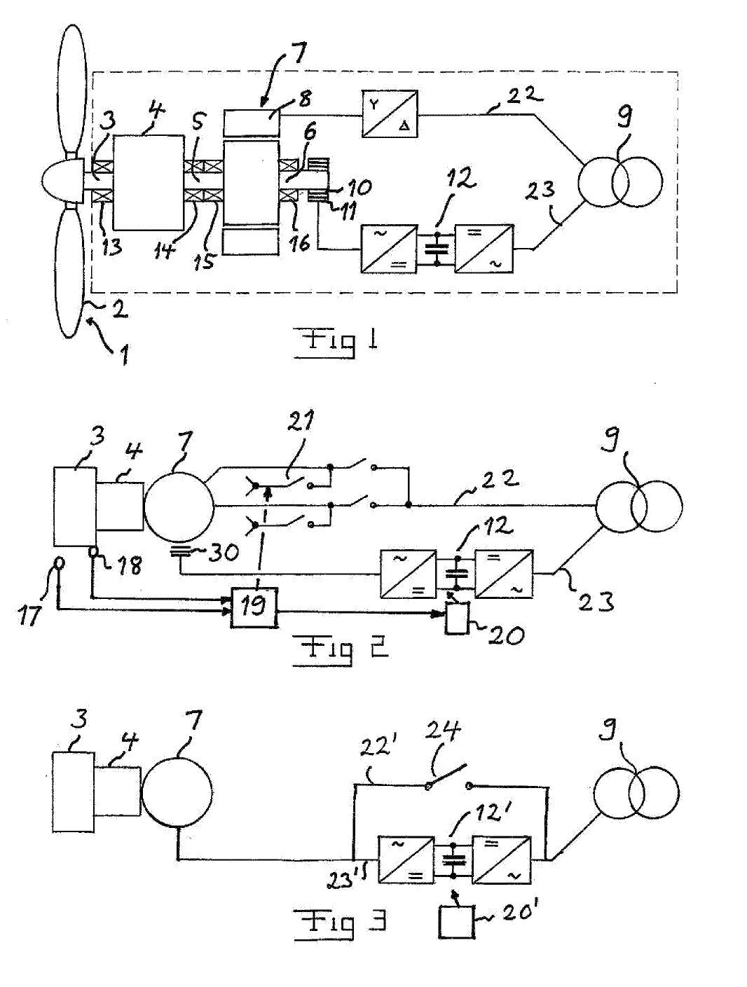

FIG. 1 illustrates very schematically the general construction of a wind turbine known as a wind turbine having a Double-Fed Induction Generator (DFIG). The part of the wind turbine within the frame of dashed lines is normally arranged in the so-called nacelle or house arranged on the column of a wind power station. The wind turbine has a propeller 1 with blades 2 arranged to catch the wind and drive a wind rotor 3 to rotate. The wind rotor has normally a rotation speed of 3-15 rpm and 5-20 rpm for a wind turbine with a rating of 3 MW and 2 MW, respectively. The wind rotor 3 is connected to a gearbox 4 normally increasing the rotational speed on an output shaft 5 thereof to be 100 times the rotational speed of the wind rotor 3 for the higher rating and 60 times for the lower rating. The output shaft 5 is connected to or carries a rotor 6 of an asynchronous generator 7 having the stator windings 8 thereof through a first branch 22 connected to an electric power transmission network not shown by being connected to a transformer 9 connected to said network.

The rotor has slip-rings 10 connecting to brushes 11 for connection of the rotor winding to a frequency converter 12, which in its turn is through a second branch 23 connected to the transformer 9 and accordingly to said power transmission network.

It is shown how the drive train from the wind rotor 3 to the rotor 6 of the generator is surrounded by bearings 13-16 for journalling the corresponding rotating parts of the drive train, upon which considerable loads and torques may be applied, not at least as a consequence of the considerable weight of for instance the propeller. These bearings as well as the rotating parts inside the gearbox 4 are lubricated by oil or grease, such as by being partially or totally immersed in an oil bath.

The stator winding 8 may be Y- or A-connected to the transformer 9 depending upon the rotational speed of the rotor 6, in which the Y-connection is used at lower speeds and otherwise the A-connection. Accordingly, the current in the stator windings has the same frequency as in said electric power transmission network, which normally means 50 Hz or 60 Hz. Electric power may also be fed to the electric power transmission network through the rotor through the connection of the windings thereof through the slip-rings and brushes to the frequency converter 12, which converts the electric power arriving thereto and having a frequency corresponding to the rotational speed of the rotor into electric power of the same frequency as the power on the electric power transmission network. The procedure of controlling such a Double-Fed Induction Generator used in a wind turbine depending upon different conditions prevailing is well known in the art and will not be further explained here.

The problems associated with a risk of wear and damage of bearings and indentations of gears in the gearbox in such a wind turbine as a consequence of poor lubrication at low power conditions of low wind velocities and/or low wind rotor speed have been thoroughly discussed above.

FIG. 2 schematically illustrates a wind turbine of the type according to FIG. 1 modified so as to address and solve these problems. It is shown how this wind turbine has means 17 for sensing the wind velocity in the region of the wind turbine and means 18 adapted to sense the speed of the wind rotor. The wind turbine further comprises means 19 receiving information from said sensing means and adapted to determine whether low power conditions, defined by a wind velocity and/or a wind rotor speed and/or a level of maximum power below a respective predetermined value, prevail. The wind turbine also comprises, as of course also the wind turbine according to FIG. 1, a control unit 20 for controlling the frequency converter, i.e. controllable semiconductor devices, such as IGBTs, thereof for converting an electric power of one frequency to an electric power of another frequency. Said determining means 19 is adapted to send information about said determination to said control unit 20, which is adapted to control the frequency converter, upon determining that said low power conditions prevail, to feed small amounts of electric power from the electric power transmission network (the transformer 9) to the rotor of the generator 7 through the brushes/slip-rings connection 30 for motor operation of the generator for raising the speed of the wind rotor above a predetermined level for lubricating parts of the drive train during said low power conditions. For obtaining this operation the determining means 19 is adapted to send information about said determining to switching means 21 adapted to short-circuit the stator winding of the generator upon determination that said low power conditions prevail.

By operating the generator 7 as a motor under such low power conditions stresses upon drive train components like a gearbox, the bearings and brushes/slip-rings in standstill, idling or low speed operation of the wind turbine may be avoided. Thus, it may for example be ensured that the wind rotor will always rotate with at least a half rotation per minute or any other suitable value for ensuring proper lubrication.

The control unit is furthermore adapted to control the frequency converter at said low power conditions to deliver a current through the brushes/slip-rings connection having an appearance favourable for lubrication of this connection. This means that the control unit may control the frequency converter to deliver exactly the current suitable for proper lubrications of the connection 30 by suitable electric arcs formed between the brushes and slip-rings for such lubrication. The generator may then be operated with a lowered air-gap flux upon determination of said low power conditions for increasing the level of the current through the brushes/slip-rings connection for lubricating the slip-rings.

FIG. 3 illustrates a wind-turbine according to another embodiment of the invention, which differs from that according to FIG. 2 by the fact that the generator 7 is an asynchronous generator with a squirrel cage wound rotor. The stator winding may be connected to a transformer 9 and by that the electric power transmission network through a first branch 22′ having a so-called by-pass contactor 24 and adapted to conduct electric power with the same frequency as said electric power transmission network. The wind turbine further comprises a second branch 23′ adapted to connect the stator windings of the generator 7 to said network through a said frequency converter 12′. At normal operation power is fed to said network through the frequency converter at lower wind speeds, whereas the by-pass contactor is closed for higher wind speeds for then feeding directly from the stator to the transformer 9. The sensing means 17-18 and the determining means 19 shown in FIG. 2 are also present in the embodiment according to FIG. 3 but left out in the figure for the sake of simplicity. The control unit 20′ is in this embodiment adapted to control the frequency converter 12′, upon determination that said low power conditions prevail, to feed electric power through said second branch 23′ to the stator windings of the generator for operating this as a motor resulting in proper lubrication of the bearings and the gearbox.

The invention is of course not in any way restricted to the embodiments described above but many possibilities to modifications thereof would be apparent to a person with ordinary skill in the art without departing from the basic idea of the invention as defined in the appended claims.

1. A method for controlling a wind turbine at low power conditions of at least one of low wind velocities and low wind rotor speed, in which said wind turbine comprises a drive train with a wind rotors connected to a generator rotor through a gearbox and bearings for journalling rotating parts of the drive train, said generator being connected to an electric power transmission network, in which the turbine further comprises a frequency converter connecting with one side to the generator and the other to said network, characterized in said method comprises the steps of:
sensing at least one of the wind velocity and the speed of said wind rotor,
determining that low power conditions prevail when said at least one of wind velocity and wind rotor speed sensed is below a predetermined value, and, upon determination that said low power conditions prevail,
controlling said frequency converter to feed electric power from said network to said generator for operating this as a motor for raising the speed of the wind rotor above a predetermined level for lubricating rotating parts of said drive train.

2. The method according to claim 1, characterized in that the control is carried out for a wind turbine having a Double-Fed Induction Generator (DFIG) with two parallel branches connecting the generator to said electric power transmission network for feeding electric power to the network through both said branches, in which said frequency converter is arranged in one of the branches and adapted to under normal power conditions be controlled to convert electric power delivered from the generator with a frequency of the generator to electric power having the frequency of said electric power network.

3. The method according to claim 1, characterized in that it is a wind turbine having an asynchronous generator that is controlled, said asynchronous generator having stator windings connected to said electric power transmission network and a rotor being connected through slip-rings and brushes to said frequency converter, in which the method comprises the following additional steps carried out upon determination that said low power conditions prevail:
the stator windings of the generator are short-circuited,
the frequency converter is controlled to feed electric power to the rotor of the generator through the connection of the brushes and slip-rings thereto for raising the speed of the wind rotor above a predetermined level for lubricating rotating parts of said drive train.

4. The method according to claim 3, characterized in that said frequency converter is at said low power conditions controlled to deliver a current through the brushes/slip-rings connection having an appearance favourable for lubrication of this connection.

5. The method according to claim 3, characterized in that the generator is operated with a lowered air-gap flux upon determination of said low power conditions for increasing the level of the current through the brushes/slip-rings connections for lubricating the slip-rings.

6. The method according to claim 1, characterized in that the control is carried out for a wind turbine having an asynchronous generator with a squirrel cage wound rotor and stator windings connected to said electric power network through said frequency converter, and that upon determination that said low power conditions prevail said frequency converter is controlled to feed electric power to the stator windings of the generator for operating this as a motor.

7. The method according to claim 1, characterized in that it is determined that low power conditions prevail when said at least one wind velocity and wind rotor speed sensed is below a value making it possible to generate a maximum power being below 5% of a rated power of the wind turbine.

8. A wind turbine comprising a drive train with a wind rotor connected to a generator rotor of a generator through a gearbox and having bearings for journalling rotating parts of the drive train, said generator being adapted to be connected to an electric power transmission network, said wind turbine further comprising a frequency converter connecting with one side to the generator and adapted to connect with the other side to said network, a control unit for controlling this converter and at least one of means adapted to sense wind velocity in a region of the wind turbine and means adapted to sense the speed of the wind rotor, characterized in that the wind turbine comprises means adapted to determine, on the basis of information from said sensing means, whether low power conditions, defined by a wind velocity and/or a wind rotor speed below a respective predetermined value, prevail, and that said control unit is adapted to control said frequency converter, upon determining that said low power conditions prevail, to feed electric power to said generator for motor operation thereof for raising the speed of the wind rotor above a predetermined level for lubricating parts of said drive train during said low power conditions.

9. The wind turbine according to claim 8, characterized in that said generator is a Double-Fed Induction Generator (DFIG) with two parallel branches connecting the generator to said electric power transmission network for feeding electric power to the network through both said branches, in which said frequency converter is arranged in one of the branches and adapted to under normal power conditions be controlled by said control unit to convert electric power delivered from the generator with a frequency of the generator to electric power having the frequency of said electric power network.

10. The wind turbine according to claim 8, characterized in that said generator is an asynchronous generator having stator windings adapted to be connected to said electric power transmission network and a rotor being connected through slip-rings and brushes to said frequency converter, that the wind turbine further comprises means adapted to short-circuit the stator windings of the generator upon determination that said low power conditions prevail, and that said control unit is adapted to control said frequency converter, upon determining that said low power conditions prevail, to feed electric power to the rotor of the generator through the connection of the brushes and slip-rings thereto for raising the speed of the wind rotor above a predetermined level for lubricating rotating parts of said drive train.

11. The wind turbine according to claim 10, characterized in that said control unit is adapted to control said frequency converter at said low power conditions to deliver a current through the brushes/slip-rings connection having an appearance favourable for lubrication of this connection.

12. The wind turbine according to claim 10, characterized in that the wind turbine comprises means adapted to operate the generator with a lowered air-gap flux upon determination of said low power conditions for increasing the level of the current through the brushes/slip-rings connection for lubricating the slip-rings.

13. The wind turbine according to claim 8, characterized in that said generator is an asynchronous generator with a squirrel cage wound rotor and stator windings adapted to be connected to said electric power network through said frequency converter, and that said control unit is adapted to control said frequency converter, upon determination that said low power conditions prevail, to feed electric power to the stator windings of the generator for operating this as a motor.

14. The wind turbine according to claim 8, characterized in that said determination means is adapted to determine that low power conditions prevail when said at least one of wind velocity and wind rotor speed sensed is below a value making it possible to generate a maximum power being below 5% of a rated power of the wind turbine.

15. The computer program directly loadable into the internal memory of a computer, which comprises computer code portions for controlling the steps of claim 1 when the program is run on a computer.

16. The computer program according to claim 15 provided at least partially through a network.

17. The computer readable medium having a computer program recorded thereon, in which said computer program is designed to make a computer control the steps according to claim 1.

18. Use of a wind turbine according to claim 8 together with a plurality of wind turbines in a wind power plant.

19. Use of a wind turbine according to claim 8 in an electric power transmission system comprising a High Voltage Direct Current (HVDC) transmission line.

20. The method according to claim 7 characterized in that it is determined that low power conditions prevail when said at least one of wind velocity and wind rotor speed sensed is below a value making it possible to generate a maximum power being below 2% of a rated power of the wind turbine.

21. The wind turbine according to claim 14, characterized in that said determination means is adapted to determine that low power conditions prevail when said at least one of wind velocity and wind rotor speed sensed is below velocity and wind rotor speed sensed is below a values making it possible to generate a maximum power being below 2% of a rated power of the wind turbine.
